(19) United States
(12) Patent Application Publication
(10) Pub. No.: US 2004/0164143 A1
(43) Pub. Date: Aug. 26, 2004

(54) Apparatus and method for disclosing and acknowledging an establishment of a real estate agency relationship

(76) Inventor: Dawn Haley, Calumet City, IL (US)

Correspondence Address: BARNES & THORNBURG, P.O. BOX 2786, CHICAGO, IL, 60690-2786, US

(21) Appl. No.: 10/762,737

(22) Filed: Jan. 21, 2004

Related U.S. Application Data
(60) Provisional application No. 60/442,149, filed on Jan. 23, 2003.

(51) Int. Cl. G06K 5/00

(52) U.S. Cl. 235/380

(57) ABSTRACT

An apparatus for facilitating the establishment of an agency relationship between real estate agents and their clients. The apparatus is a card identifying the name of the designated agent and the client. The card may include contact information for the agent and a notice that the card should not be used to promote viewing without the designated agent being present. The apparatus may also include a form for selecting the type of agency relationship with at least one card detachably attached thereto. A method for establishing and acknowledging an agency relationship. A card identifying the designated agent and client is given to the client to take with them to all showings. The client is instructed to present the card to all outside agents. The outside agents see the card and are thereafter notified of the client's selection of the designated agent.

### CROSS-REFERENCE TO RELATED APPLICATIONS

This application claims benefit of the U.S. Provisional Application Serial No. 60/442,149, filed Jan. 23, 2003. The Provisional Application is incorporated herein by reference.

### BACKGROUND AND SUMMARY

The present disclosure relates generally to an apparatus and method for disclosing and acknowledging the establishment of an agency relationship between a real estate agent and a real estate buyer. Real estate agents assist buyers in a variety of ways including notifying buyers of listings, visiting properties, valuation, submitting offers and counteroffers, and understanding the buying process. In most cases, real estate agents do this because they receive a commission at closing. Where more than one agent is involved in the purchase, various ethics codes and guidelines published by real estate governing associations such as the National Association of Realtors® dictate that the commission should be paid to the “procuring cause” of the sale. Often costly disputes arise about which agent, where more than one agent is involved, was the procuring cause.

One example of where a dispute may arise is when a listing agent shows a property to a potential buyer and the buyer then hires another agent to represent them. In this example, the listing agent may claim to be the procuring cause because the listing agent showed the property first. Because of such incidents, buyer's agents are often worried that their clients will be stolen by listing agents. It would be useful to provide buyer's agents with a protective apparatus and method which facilitates their clients affirmatively selecting them as their designated agent and which puts all other agents coming in contact with the client (“outside agents”) on notice of that designation.

Briefly, and in accordance with the foregoing, disclosed is an apparatus for facilitating the establishment of an agency relationship between real estate agents and their clients. One embodiment of the apparatus is a card identifying the name of the designated agent and the client. Desirably, the card includes contact information for the agent and a notice that the card should not be used to promote viewing without the designated agent being present. The apparatus may also include a form for selecting the type of agency relationship with at least one card detachably attached thereto.

Also disclosed is a method for establishing and acknowledging an agency relationship. A card identifying the designated agent and client is given to the client to take with them to all showings. The client is instructed to present the card to all outside agents. The outside agents see the card and are thereafter notified of the client's selection of the designated agent.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a simplified view of the front side a card for disclosing the establishment of an agency relationship;

FIG. 2 is simplified view of the back side of the card of FIG. 1;

FIG. 3 is an example of the front side of a card for disclosing the establishment of an agency relationship;

FIG. 4 is a simplified view of the back side of the card of FIG. 3;

FIG. 5 is an example of a form for facilitating the selection of an agency relationship with two copies of the card of FIG. 1 or FIG. 2. attached thereto;

FIG. 6 is a simplified diagrammatic view of a card for disclosing the establishment of an agency relationship which includes a magnetic strip; and

FIG. 7 is a simplified view of the card of FIG. 6 in combination with magnetic card reader and locking mechanism.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

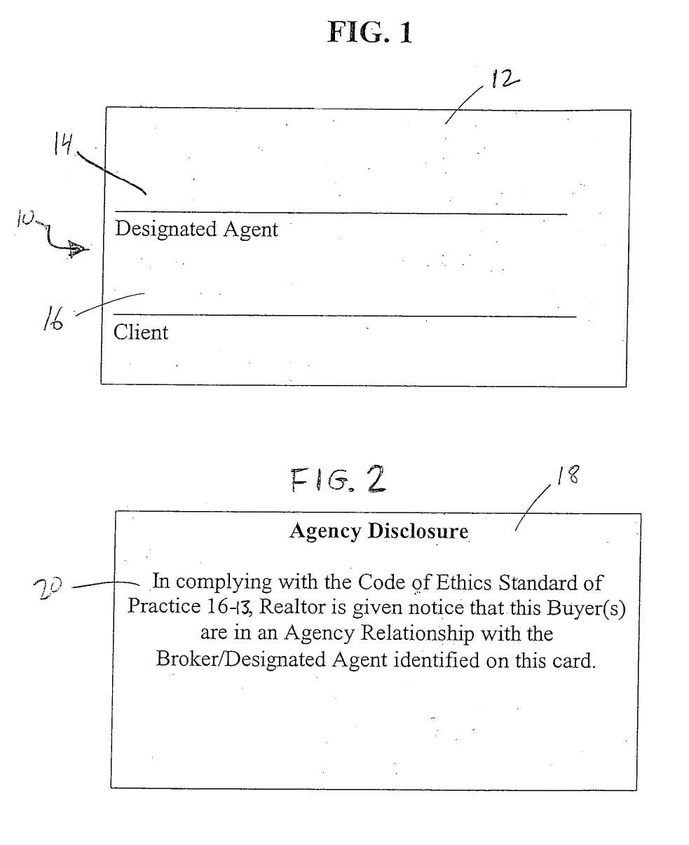

With reference to the figures, FIG. 1 shows a card 10 illustrating one embodiment of the apparatus for disclosing the establishment of an agency relationship. The card 10 is constructed from paper, plastic, or the like and may be laminated for protection. The front side 12 of the card 10 includes at least two areas for recording information relevant to disclosing the establishment of the agency relationship. The first area is a designated agent area 14 for writing or printing indicia corresponding to the name of the designated agent, referred to hereafter as the designated agent indicia. The second area is a client area 16 for recoding, such as writing in or printing, indicia corresponding to the name of a client, referred to hereafter as client indicia. In FIG. 1, areas 14, 16 are labeled “Designated Agent” and “Client.” Variations of the “Designated Agent” label may be used such as, for example, “Agent,” “Broker,” and “Buyer's Agent.” Variations may also be utilized for the “Client” label such as, for example, “Buyer” or “Customer.”

As shown in FIG. 2, the back side 18 of the card 10 contains an agency disclosure in the form of agency disclosure indicia 20. Although any message conveying that the client and designated agent listed on the front have established an agency relationship may be used, one example of such a message is “Agency Disclosure; in complying with the Code of Ethics Standard of Practice 16-13, Realtor is given notice that this Buyer(s) are in an Agency Relationship with the Broker/Designated Agent identified on this card.” Section 16-13 mentioned in this sample language refers to the applicable section of the Code of Ethics and Standards of Practice of the National Association of Realtors® (01/03) which states:

All dealings concerning property exclusively listed, or with buyer/tenants who are subject to an exclusive agreement shall be carried on with the client's agent or broker, and not with the client, except with the consent of the client's agent or broker or except where such dealings are initiated by the client.

Before providing substantive services (such as writing a purchase offer or presenting a CMA) to prospective purchasers, sellers, tenants, or landlords (“prospects”), Realtors® shall ask prospects whether they are a party to any exclusive representation agreement. Realtors® shall not knowingly provide substantive services concerning a prospective transaction to prospects who are parties to exclusive representation agreements, except with the consent of the prospects' exclusive representatives or at the direction of prospects.

The agency disclosure indicia 20 clearly discloses such a pre-existing relationship and reminds the outside broker of the outside broker's obligation under the Code of Ethics. Substitute citations to other relevant Codes or guidelines may be used where rules other than the ethics rules for Realtors® govern. The back side 18 may also contain an expiration date for the agency relationship where such a date has been agreed upon. The identification of one side of the card as the front side and the other as the back side is for convenience in this description only. The information described above as being a particular side may be reversed or may be distributed differently as well.

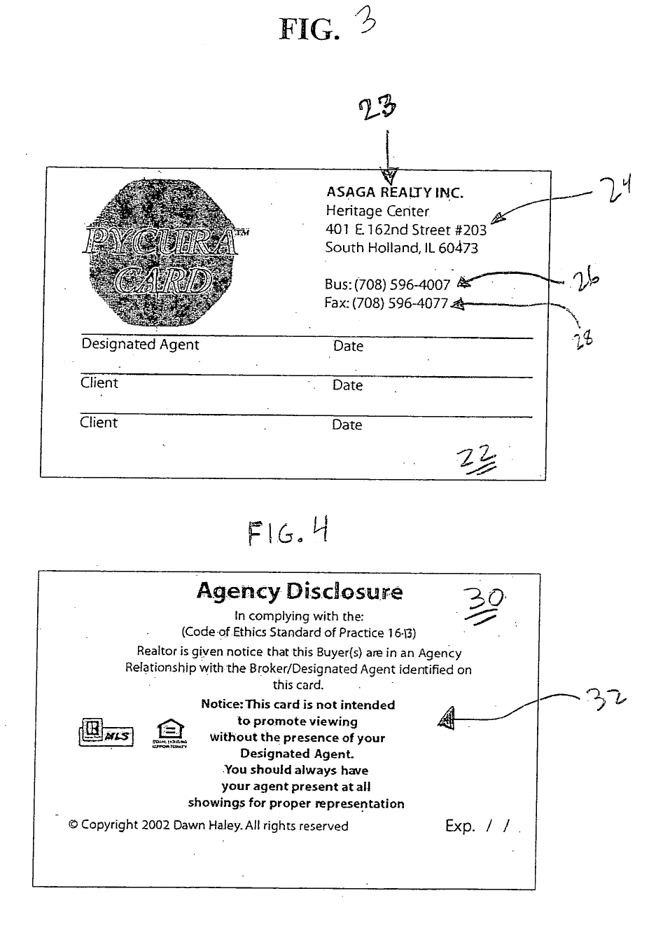

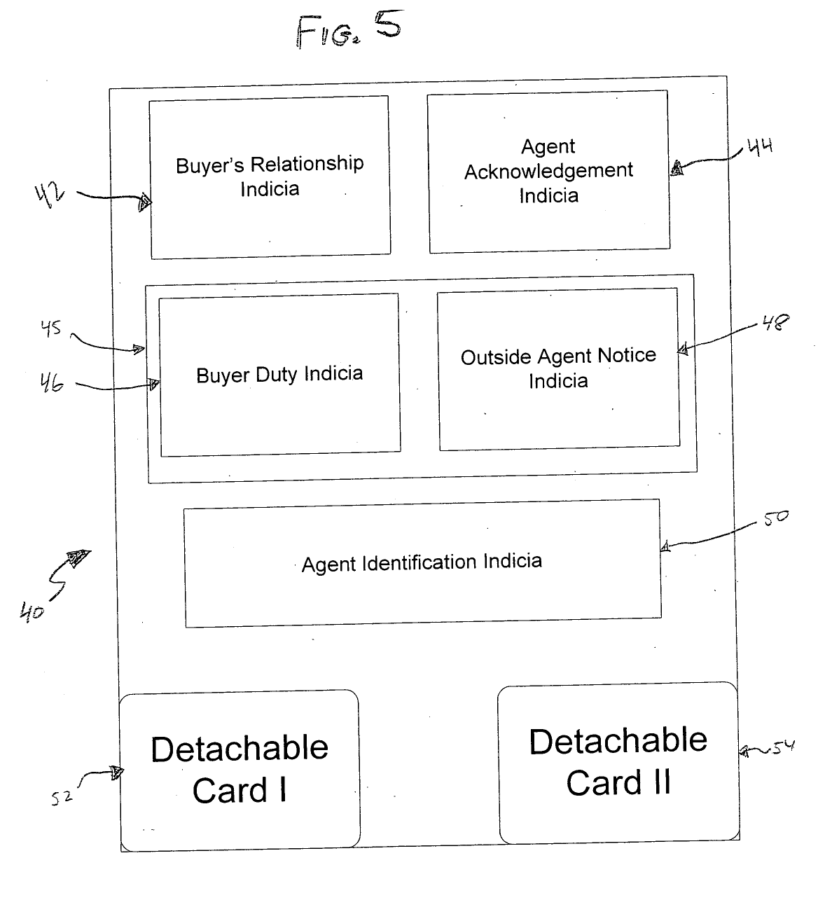

As illustrated in FIG. 3, the card 10 may also include additional contact indicia 23. The front of the card 22 may also include address indicia 24, telephone number indicia 26 and fax number indicia 28 related to the designated agent or broker. Other information such as web site indicia or email indicia may also be included. The back side 30, shown in FIG. 4, may also contain additional information such as indicia for indicating the purpose of card 32. For example, the notice may state, “Notice: This card is not intended to promote viewing without the presence of your Designated Agent. You should always have your agent present at all showings for proper representation.” This message reminds the buyer to contact their designated agent for showings further improving the likelihood the designated agent will be considered the procuring cause of the sale should a dispute arise. Other messages that provide this meaning may be used as well.

In use, the agent or client records appropriate information on the card 10 using either a writing instrument such as pen or a by printing the card 10 on a printer. The agent then instructs the client to carry the card 10 to all showings and present the card 10 to any outside agents immediately upon arrival. The outside agent is thereafter put on notice of the established real estate agency relationship. This may prevent the outside agent from making an ethical violation by acting in a manner inconsistent to that established relationship. In this manner, the client is not “stolen” and a costly procuring cause dispute is avoided.

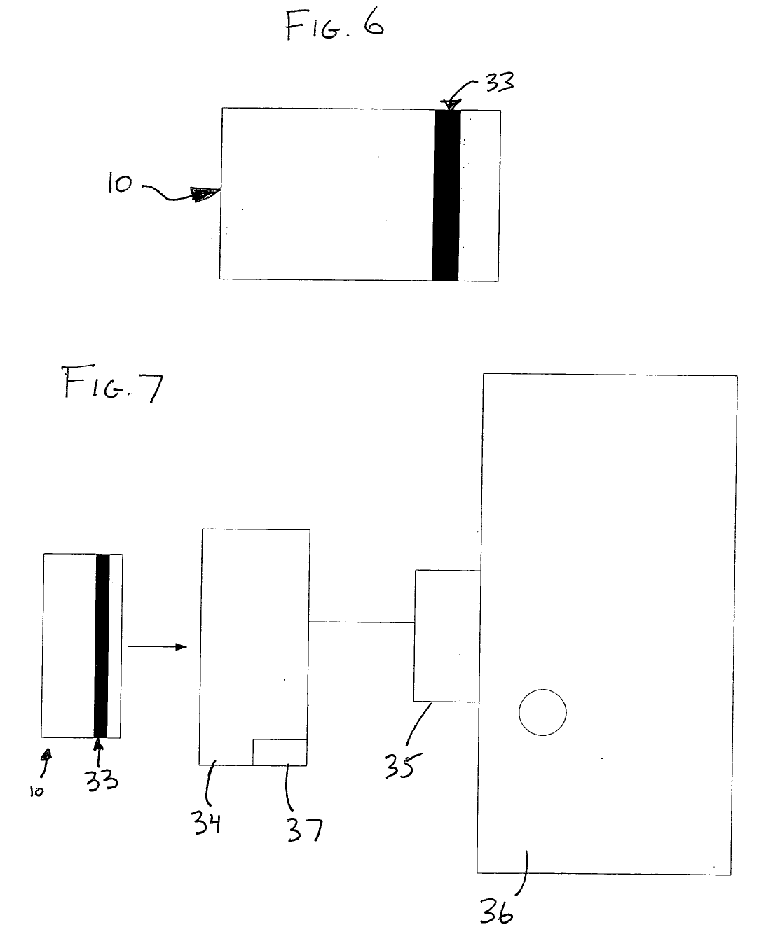

In another embodiment shown in FIG. 6, a magnetic strip 33 may be integral with the card 10 which contains at least information identifying the client and designated agent. The magnetic strip 33 may further include information identifying the designated agent's contact information and other details about the type of agency relationship. As shown in FIG. 7, in use, a magnetic strip reader 34 may be installed at listed real estate properties and be used to collect information about visitors. Information is collected as the card 10 is passed through the reader 34 including details of the agency disclosure which notifies the outside agent of the established agency relationship. In an alternative embodiment, the magnetic card reader 34 may be used in connection with a locking device 35 positioned at the entry 36, such as a door or gate, of the property. The reader 34 confirms the card holder's identity prior to unlocking. In this manner, properties may be shown without an outside agent present, provided the visitor is a pre-authorized buyer, or other permitted individual(s). The card reader 34 may also include an output means 37, such as a communications port, network connection, or other electrical or wireless connection to computing devices, for sending information about visitors to other devices such as computers.

In use, the magnetic strip embodiment of the card 10 is provided to the client. Information corresponding at least to the one or more of the designated agent indicia, client indicia, and agency disclosure indicia is stored on the magnetic strip 33, which may be accomplished used industry known magnetic card writing technologies. Designated agent indicia and client indicia is recorded on the card as well. In addition to presenting the card 10 to outside agents, the client may also swipe the card 10 on the magnetic card reader 34 positioned at visited properties for the purposes discussed above. Additionally, the information on the card 10 may be used to have the reader controllably operate a locking mechanism 35 communicating with the reader to unlock an entry point 36, such as gate or door, to permit entry therein.

Referring to FIG. 5, a form or printable sheet 40 may also be presented to the client to guide them through the agency selection process by presenting them with a choice of different types of agency relationships. A buyer's relationship section 42 is included to allow recording of the type of agency relationship selected. The buyer's relationship section 42 will include buyer's relationship indicia such a number of check boxes corresponding to different relationship types. Examples of check box choices include but are not limited to: “(A) Buyer(s) have read, signed, and received a copy of the “Exclusive Buyer Representation/Exclusive Right to Purchase Contract”, “(B) Buyer(s) have read, signed, and received a copy of the “Non-Exclusive Buyer Representation Contract”, and “(C) Buyer(s) have declined any formal written agency agreement.” Other indicia corresponding to affirming or selecting other variances on agency relationship may be used as well. The form 40 may also include an agent acknowledgment section 44 that includes agent acknowledgement indicia, the selection of which shows the agent has acknowledged the buyer's choice of relationship type.

Form 40 may also include a duty section 45. Duty section 45 contains an explanation of the client's duties while carrying the card in the form of buyer duty indicia shown in a buyer duty indicia section 46. Duties may include the duty to present the card to any outside agents when attending a showing. Further, the duty section 45 includes outside agent notice indicia in an outside agent notice section 48 which explains the outside agent's duties when shown the card. Outside agent duties include responding to calls and emails asking about the property and showing the property with an understanding that the client already has a designated agent. The form may also contain a reminder that the card is not intended to promote viewing without the presence of the designated agent. Rather, the card is used when, for whatever reason, the designated agent cannot be present. Agent identification indicia may be provided in an agent identification section 50 to clearly identify the designated agent.

Form 40 also includes detachable cards 52, 54, each which correspond to the card 10 in FIGS. 1-2. Although two detachable cards 52, 54 are shown, form 40 may also include only one detachable card, or have more than two detachable cards.

Detachable cards 52, 54 are attached by an appropriate attachment structure, such as a performed edge, or by any other appropriate adhesion for easy detachment. A client can read the information on the form, record or select the various indicia described above, and then detach cards 52, 54. The designated agent may retain the form, or a copy thereof, for their records.

In use, the client is presented with form 40 for review. The client may select a particular type of representation by checking or otherwise selecting a box or selection device next to one of the choices, initialing or otherwise indicating approval next to a choice, or performing some combination thereof. After reviewing the form and making a selection about the type of representation, the client or agent fill in or otherwise indicate the name of the designated agent and the name of the client on each card. Each card is then detached and given to the client for use. This process and method take the form of a manual process in which the information and indicia are completed manually as well as an automatic process in which a computer is partially used to complete the process. In embodiments that use a magnetic strip 33 integral with detachable cards 52, 54, information related to the buyer's selections would be written or programmed onto the magnetic strip 33 as well, either prior to or generally shortly after detachment.

While this disclosure has been described as having an exemplary embodiment, this application is intended to cover any variations, uses, or adaptations using its general principles. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. An apparatus for disclosing and acknowledging the establishment of a real estate agency relationship, the apparatus comprising:
a card, the card having a front side and a back side;
an agent designation area for placing designated agent indicia and a client area for placing client indicia, the client area and agent designation area being on one of the front side and the back side; and
agency disclosure indicia on the other of the front side and back side.

2. The apparatus of claim 1 further comprising the designated agent indicia including additional contact indicia.

3. The apparatus of claim 2 further comprising the additional contact indicia including one or more of telephone number indicia, fax number indicia, web page indicia, and email indicia.

4. The apparatus of claim 1, further comprising the agency disclosure indicia including indicia for indicating the purpose of the card.

5. The apparatus of claim 1, further comprising a magnetic strip integral with the card for storing information related to one or more of the designated agent indicia and the client indicia.

6. An apparatus for disclosing and acknowledging the establishment of a real estate agency relationship, the apparatus comprising:
a printable sheet, the printable sheet having at least one detachable card portion attached by an attachment structure to the printable sheet;
the detachable card portion having a front side and a back side, an agent designation area for placing designated agent indicia and a client area for placing client indicia, the client area and agent designation area being on one of the front side and the back side, and agency disclosure indicia on the other of the front side and back side;
the printable sheet having indicia for disclosing and acknowledging the establishment of real estate agency relationship.

7. The apparatus of claim 6 further comprising the attachment structure being a perforated edge.

8. The apparatus of claim 6, the printable sheet further comprising a buyer's relationship section for placing buyer's relationship indicia.

9. The apparatus of claim 6, the printable sheet further comprising an agent's acknowledgment section for placing agent acknowledgement indicia.

10. The apparatus of claim 6, the printable sheet further comprising duty disclosure indicia, the duty disclosure indicia including one or both of buyer duty indicia and outside agent notice indicia.

11. The apparatus of claim 10, the printable sheet further comprising a designated agent identification section for placing agent identification indicia.

12. A method for disclosing and acknowledging the establishment of a real estate agency relationship, the method comprising the steps of:
providing a client with a card, the card having a front side and a back side;
an agent designation area for placing designated agent indicia and a client area for placing client indicia, the client area and agent designation area being on one of the front side and the back side; and agency disclosure indicia on the other of the front side and back side;
recording designated agent indicia in the agent designation area;
recording client indicia in the client area; and
having the client present the card to all other agents to disclose the establishment of real estate agency relationship.

13. A method for disclosing and acknowledging the establishment of a real estate agency relationship, the method comprising the steps of:
providing a client with a card, the card having a front side and a back side;
an agent designation area for placing designated agent indicia and a client area for placing client indicia, the client area and agent designation area being on one of the front side and the back side; agency disclosure indicia on the other of the front side and back side; and a magnetic strip for storing information corresponding to one or more of the designated agent indicia, client indicia, and agency disclosure indicia;
storing the information on the magnetic strip;
recording designated agent indicia in the agent designation area;
recording client indicia in the client area;
having the client present the card to all other agents to disclose the establishment of real estate agency relationship; and
having the client use the card to communicate with a magnetic card reader at a visited property.

14. The method of claim 13, further comprising relaying the information to one or both of a seller and a seller's agent.

15. The method of claim 13, further comprising:
providing a locking mechanism on the entry of the visited property, the locking mechanism being attached to a magnetic card reader; and
in response to magnetic card reader reading a card storing information corresponding to a pre-authorized buyer, having the locking mechanism unlock to allow entry through the door.

16. A system for disclosing and acknowledging the establishment of a real estate agency relationship and for selectively allowing entry into a property, the system comprising:
a card, the card having a front side and a back side; an agent designation area for placing designated agent indicia and a client area for placing client indicia, the client area and agent designation area being on one of the front side and the back side; agency disclosure indicia on the other of the front side and back side; and a magnetic strip for storing information corresponding to one or more of the designated agent indicia, client indicia, and agency disclosure indicia; and
a magnetic card reader positionable at real estate property for reading information from the card.

17. The system of claim 16 further comprising a locking mechanism in communication with the magnetic card reader for controllably locking and unlocking an entry door of the real estate property.

18. The system of claim 16 further comprising a output means on the magnetic card reader for outputting the information to a computing device.
